(19) United States
(12) Patent Application Publication
(10) Pub. No.: US 2015/0309996 A1
(43) Pub. Date: Oct. 29, 2015

(54) INFORMATION PROCESSING SYSTEM, INFORMATION PROCESSING APPARATUS, AND INFORMATION PROCESSING METHOD

(71) Applicant: Xiaofeng HAN, Kanagawa (JP)

(72) Inventor: Xiaofeng HAN, Kanagawa (JP)

(21) Appl. No.: 14/682,495

(22) Filed: Apr. 9, 2015

(30) Foreign Application Priority Data
Apr. 25, 2014 (JP) 2014-092061

(51) Int. Cl. G06F 17/28

(52) U.S. Cl. CPC G06F 17/289

(57) ABSTRACT

An information processing system includes an acquiring unit, a first determining unit, a second determining unit, and a translating unit. The acquiring unit acquires first information that includes image data. The first determining unit determines the translation source language that indicates the language used in the image data in accordance with the result of a character recognition operation during which a character included in the image data is recognized and text data is generated. The second determining unit determines that the language used for a display in an information processing apparatus is the translation target language. The translating unit performs a translation operation to convert text data that is represented by using the translation source language into text data that is represented by using the translation target language.

### CROSS-REFERENCE TO RELATED APPLICATIONS

The present application claims priority to and incorporates by reference the entire contents of Japanese Patent Application No. 2014-092061 filed in Japan on Apr. 25, 2014.

### BACKGROUND OF THE INVENTION

1. Field of the Invention

The present invention relates to an information processing system, an information processing apparatus, and an information processing method.

2. Description of the Related Art

In recent years, there have been known systems in which translations are performed on electronic data by using a multifunction peripheral and a web server via a network. For example, Japanese Laid-open Patent Publication No. 2009-246807 discloses, to determine the language used in document data (text data) that is received via a communication line, the configuration for previously storing language determination information for determining the used language and the configuration for comparing the language determination information on the received document data with the stored language determination information.

However, in the technology disclosed in Japanese Laid-open Patent Publication No. 2009-246807, a configuration is such that a symbol for determining a language is embedded in an original document and the symbol is taken from the original document so that the symbol is determined; therefore, it is necessary to previously embed the symbol for determining a language in an original document, and it is unnecessarily time-consuming. Specifically, users need to previously set the language used in an original document.

Conventionally, there are no systems for automatically setting the translation source language that is the language representing document data before a translation and the translation target language that is the language representing document data after a translation.

Therefore, it is desirable to provide an information processing system, an information processing apparatus, and an information processing method that make it possible to automatically set the translation source language and the translation target language.

### SUMMARY OF THE INVENTION

It is an object of the present invention to at least partially solve the problems in the conventional technology.

According to an aspect of the present invention, there is provided an information processing system including: an acquiring unit that acquires first information that includes image data; a first determining unit that determines a translation source language that indicates a language used in the image data in accordance with a result of a character recognition operation during which a character included in the image data is recognized and text data is generated; a second determining unit that determines that a language used for a display in an information processing apparatus is a translation target language; and a translating unit that performs a translation operation to convert the text data that is represented by using the translation source language into the text data that is represented by using the translation target language.

According to another aspect of the present invention, there is provided an information processing apparatus including: an acquiring unit that acquires first information that includes image data; a first determining unit that determines a translation source language that indicates a language used in the image data in accordance with a result of a character recognition operation during which a character included in the image data is recognized and text data is generated; a second determining unit that determines that a language used for a display in an information processing apparatus is a translation target language; and a transmitting unit that transmits, to a translation server that performs a translation, the text data that is represented by using the translation source language, information that indicates the translation source language, and information that indicates the translation target language.

According to still another aspect of the present invention, there is provided an information processing method performed by an information processing apparatus, the information processing method including: acquiring first information that includes image data; determining a translation source language that indicates a language used in the image data in accordance with a result of a character recognition operation during which a character included in the image data is recognized and text data is generated; determining that a language used for a display in the information processing apparatus is a translation target language; and transmitting, to a translation server that performs a translation, the text data that is represented by using the translation source language, information that indicates the translation source language, and information that indicates the translation target language.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram that illustrates an example of the configuration of an information processing system according to a first embodiment;

FIG. 2 is a diagram that illustrates an example of the correspondence relationship between the country code included in a FAX number and the used language;

FIG. 3 is a diagram that illustrates an example of text data that is obtained during an OCR operation for which a translation source language is used as a recognition language;

FIG. 4 is a diagram that illustrates an example of the correspondence relationship between the language that is indicated by display language information and a translation target language;

FIG. 5 is a diagram that illustrates an example of translation data that is obtained during a translation operation;

FIG. 6 is a flow that illustrates an operation example of a translation server when a translation operation is performed as an automatic operation;

FIG. 7 is a flow that illustrates an operation example of the translation server when a translation operation is performed as a manual operation; and

FIG. 8 is a diagram that illustrates an example of the configuration of an information processing system according to a second embodiment.

### DETAILED DESCRIPTION OF THE PREFERRED EMBODIMENTS

With reference to the attached drawings, a detailed explanation is given below of an embodiment of an information processing system, an information processing apparatus, an information processing method, and a program according to the present invention. In the following, an explanation is given of, for example, a case where the information processing apparatus according to the present invention is applied to an image forming apparatus (for example, a multifunction peripheral (MFP)); however, this is not a limitation.

### First Embodiment

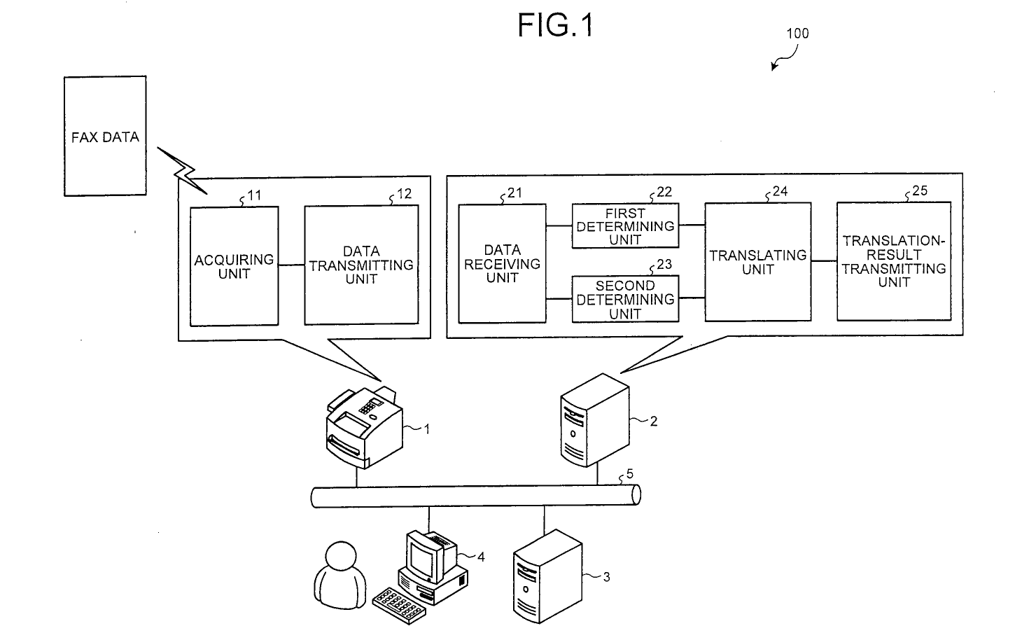

FIG. 1 is a diagram that illustrates an example of the configuration of an information processing system 100 according to a first embodiment. As illustrated in FIG. 1, the information processing system 100 includes an image forming apparatus (an MFP in this example) 1, a translation server 2, a storage server 3, and a PC 4, and they are capable of communicating with one another via a network 5. The PC 4 is a terminal device that is used when a user (administrator) checks the result of a translation, and it may be configured as, for example, a smartphone. In this example, an explanation is given by using, as input data, FAX data that represents electronic data (image data) that is received by a FAX app (the application for providing a FAX function) that is installed in the image forming apparatus 1; however, this is not a limitation. For example, it is applicable to a case of a transmission, to a server, of image data that is obtained during a scan operation to read images from an original document.

As illustrated in FIG. 1, the image forming apparatus 1 includes an acquiring unit 11 and a data transmitting unit 12. For the convenience of explanation, only the functions related to the present invention are illustrated in FIG. 1; however, they are not limitations of the functions that are provided by the image forming apparatus 1. The acquiring unit 11 acquires first information that includes image data. More specifically, the first information includes second information that makes it possible to determine a country or region and, in this example, the second information is a FAX number that indicates a FAX transmission source. The acquiring unit 11 according to the present embodiment has a function to receive data or transmit data by using a FAX, and it is capable of transferring the FAX data or the FAX number that is received via a phone line or the network 5 to a device on the network 5. In this example, the FAX data is equivalent to “image data” in claims.

The data transmitting unit 12 transmits, to the translation server 2, the FAX data and the FAX number that are acquired by the acquiring unit 11 and the display language information that indicates the language that is used for a display in the image forming apparatus 1. The image forming apparatus 1 includes an operating unit (not illustrated) that receives a user's operation and that displays various types of information, and the data transmitting unit 12 is capable of acquiring, from the setting information (stored in, for example, an undepicted memory) that indicates various settings of the image forming apparatus 1, the display language information (i.e., the information that indicates the language that is set as the language for a display in the image forming apparatus 1) that is set in an UI of the operating unit.

The data transmitting unit 12 transmits data by POST if a transmission is conducted on the basis of, for example, the Hypertext Transfer Protocol (HTTP). Specifically, the FAX number (the country code, the area code, or the like) and the display language information are set to a transmission header, and FAX data is set to a transmission body (for example, received FAX data may be embedded in a binary mode). This is not a limitation, and a transmission method based on the HTTP may be used.

Examples of the URL that indicates a transmission destination include “http(s)://[host name]/ricoh-mfp-web/mfpTranReq/upload”. Furthermore, examples of the transmission header include “X-fax-country-code:[country code]”, “X-fax-area-code:[area code]”, or “X-mfp-ui-language:[display language information]”. Moreover, examples of a response code include “200:0K” or “400:parameter error (unusable and different type of parameter is designated)”.

Furthermore, according to the present embodiment, the image forming apparatus 1 has a hardware configuration that uses a computer device that includes a CPU, a storage device such as a ROM or a RAM, a communication I/F for communicating with the translation server 2, or the like, and a display unit that displays various images, and the functions (the acquiring unit 11 and the data transmitting unit 12) of the units of the above-described image forming apparatus 1 are implemented when the CPU executes a program that is stored in a storage device. This is not a limitation and, for example, at least some of the functions of the units of the above-described image forming apparatus 1 may be implemented by a dedicated hardware circuit (for example, a semiconductor integrated circuit).

Next, an explanation is given of the translation server 2. For the convenience of explanation, only the functions related to the present invention are illustrated in FIG. 1; however, this is not a limitation of the functions that are provided by the translation server 2. As illustrated in FIG. 1, the translation server 2 includes a data receiving unit 21, a first determining unit 22, a second determining unit 23, a translating unit 24, and a translation-result transmitting unit 25.

The data receiving unit 21 receives, from the image forming apparatus 1, data that includes the FAX number, FAX data, and display language information. Then, the data receiving unit 21 transmits, to the first determining unit 22, the FAX number and the FAX data that are included in the received data and transmits, to the second determining unit 23, the display language information that is included in the received data.

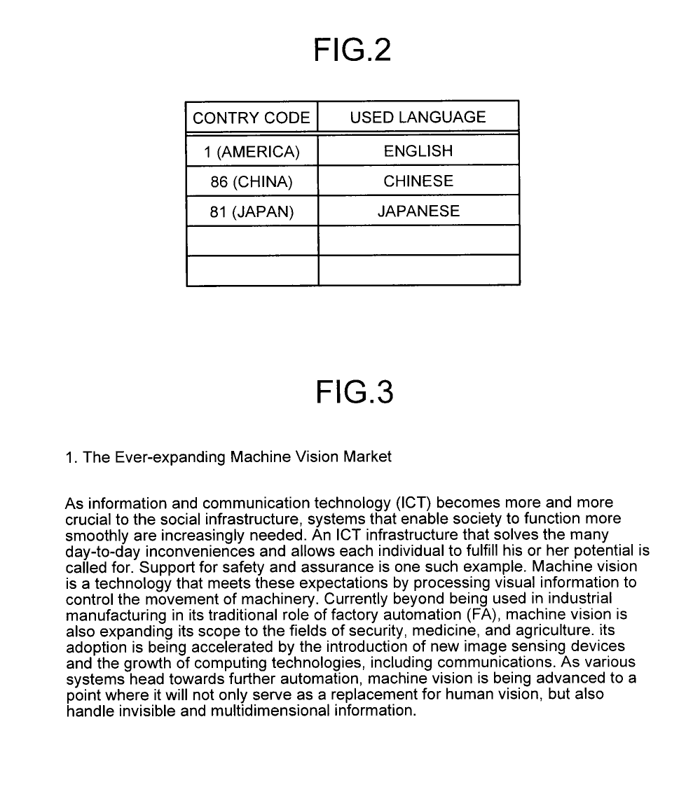

The first determining unit 22 has a function to determine the translation source language that represents the language used in FAX data on the basis of the result of a character recognition operation (an OCR operation in this example) during which characters included in image data (FAX data in this example) are recognized and text data is generated. According to the present embodiment, the first determining unit 22 determines the translation source language on the basis of the FAX number and the result of an OCR operation. More specifically, the first determining unit 22 performs an OCR operation by using, as a recognition language, the language that is used in the country or region that is determined according to the FAX number and, if the recognition rate (character recognition success rate) exceeds a threshold, it is determined that the language used in the country or region that is determined according to the FAX number is the translation source language. FIG. 2 is a diagram that illustrates an example of the correspondence relationship between the country code included in a FAX number and the used language. First, the first determining unit 22 performs an OCR operation by using, as a recognition language, the used language that corresponds to the country code that is included in the FAX number.

An explanation is continued with reference back to FIG. 1. If the recognition rate, which indicates the result of an OCR operation for which the language used in the country or region that is determined according to the FAX number is used as a recognition language, is equal to or less than a threshold (for example, including a case where a number is unknown, such as an anonymous number), the first determining unit 22 performs, with respect to each of predetermined candidate languages, an OCR operation by using the corresponding candidate language as a recognition language and determines that the candidate language with the highest recognition rate is the translation source language.

According to the present embodiment, the language used in the country that is determined according to the FAX number is used with priority as a recognition language that is necessary during an OCR operation. It may be determined by using an area code in detail after being determined by using the FAX number (country code) with a high determination accuracy (for example, if multiple languages are used in a single country, a recognition language may be determined by using an area code (determining a region)).

Furthermore, the first determining unit 22 transmits, to the translating unit 24, the information that indicates the translation source language and the text data (the text data that is represented by using the translation source language) that is obtained during an OCR operation for which the translation source language is used as a recognition language. FIG. 3 is a diagram that illustrates an example of text data that is obtained during an OCR operation for which the translation source language (Japanese in this example) is used as a recognition language.

For example, the translation server 2 may have a function (an equivalent of “a setting unit” in claims) to previously set a target area in FAX data for an OCR operation. For example, the title only, units of pages, or the entire text may be set as the target area for an OCR operation in accordance with a user's input.

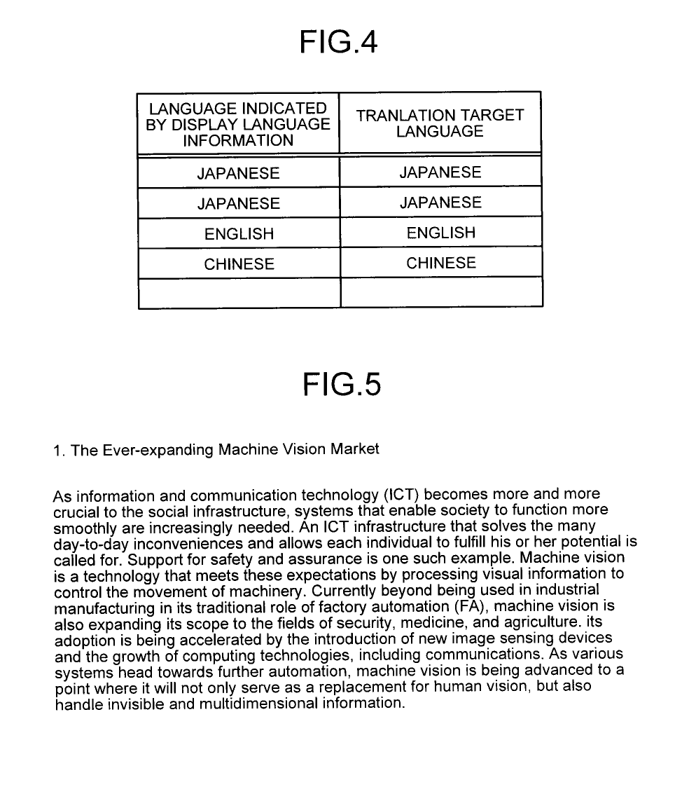

An explanation is continued with reference back to FIG. 1. The second determining unit 23 determines that the language that is used for a display in the image forming apparatus 1 is the translation target language. According to the present embodiment, the second determining unit 23 determines that the language that is indicated by the display language information that is transmitted from the data receiving unit 21 is the translation target language. FIG. 4 is a diagram that illustrates an example of the correspondence relationship between the language that is indicated by the display language information and the translation target language. Furthermore, the second determining unit 23 transmits the information that indicates the translation target language to the translating unit 24.

An explanation is continued with reference back to FIG. 1. The translating unit 24 performs a translation operation to convert the text data that is represented by using the translation source language into the text data that is represented by using the translation target language. FIG. 5 is a diagram that illustrates an example of translation data that represents text data that is obtained during a translation operation. In the example of FIG. 5, the translation target language is English. Furthermore, according to the present embodiment, there are two patterns of a translation operation, i.e., an automatic operation and a manual operation and, in the case of a manual operation, the flow is as follows: a user is notified of a completion of an OCR operation, a user checks the language that represents the text data that is obtained during the OCR operation, and then a translation operation is started in accordance with a user's instruction. The flow is described later.

The translation-result transmitting unit 25 transmits the translation data and the FAX data to the storage server 3.

According to the present embodiment, the translation server 2 has a hardware configuration that uses a computer device that includes a CPU, a storage device such as a ROM or a RAM, a communicate I/F for communicating with the image forming apparatus 1, or the like, and a display unit that displays various images, and the functions (the data receiving unit 21, the first determining unit 22, the second determining unit 23, the translating unit 24, and the translation-result transmitting unit 25) of the units of the above-described translation server 2 are implemented when the CPU executes a program that is stored in the storage device. This is not a limitation and, for example, at least some of the functions of the units of the above-described translation server 2 may be implemented by a dedicated hardware circuit (for example, a semiconductor integrated circuit).

For example, a configuration may be such that the translation server 2 is configured by using multiple servers and the functions of the units of the above-described translation server 2 are separately installed in multiple servers. In short, a configuration may be such that the information processing system according to the present invention has the function that corresponds to the above-described acquiring unit 11, the function that corresponds to the above-described first determining unit 22, the function that corresponds to the above-described second determining unit 23, and the function that corresponds to the above-described translating unit 24.

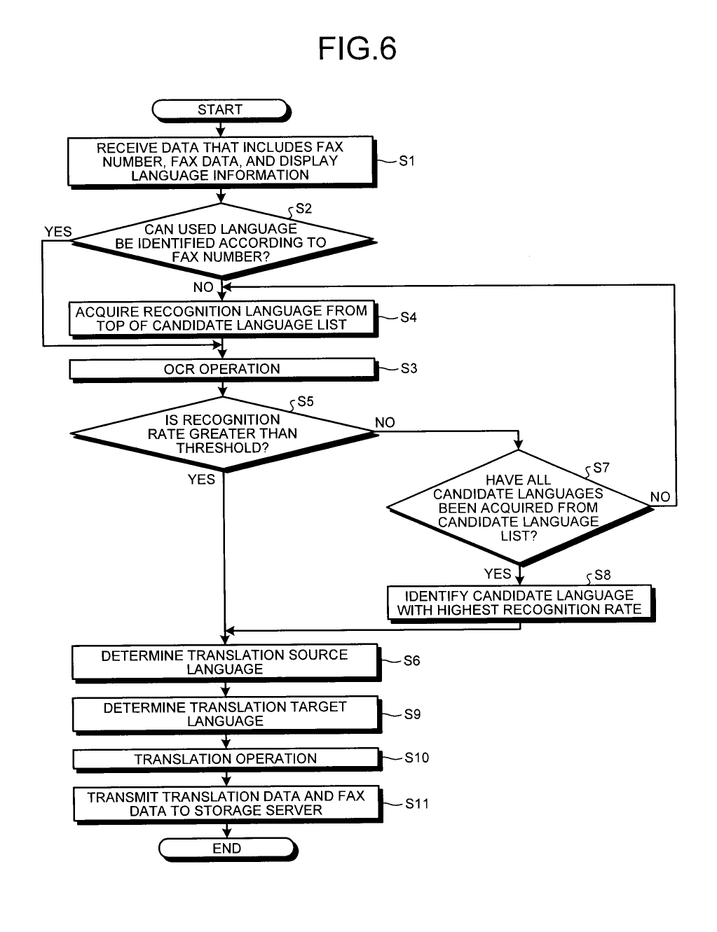

Next, with reference to FIG. 6, an explanation is given of an operation example of the translation server 2 when a translation operation is performed as an automatic operation. FIG. 6 is a flowchart that illustrates an operation example of the translation server 2 when a translation operation is performed as an automatic operation. As illustrated in FIG. 6, the data receiving unit 21 first receives, from the image forming apparatus 1, data that includes the FAX number, FAX data, and display language information (Step S1). Next, the first determining unit 22 determines whether the used language can be identified according to the FAX number (Step S2) and, if the used language can be identified (Step S2: Yes), an OCR operation is performed by using the used language as a recognition language (Step S3). Conversely, if it is difficult to identify the used language (Step S2: No), a single candidate language is acquired from a candidate language list that represents a set of predetermined candidate languages (Step S4). For example, a configuration may be such that a selection is sequentially made from the top of the candidate language list. Then, an OCR operation is performed by using the acquired candidate language as a recognition language (Step S3).

If the recognition rate, which indicates the result of the OCR operation at the above-described Step S3, is greater than a threshold (Step S5: Yes), the first determining unit 22 determines that the recognition language used during the OCR operation is the translation source language (Step S6). Conversely, if the recognition rate is equal to or less than the threshold (Step S5: No), the first determining unit 22 determines whether all the candidate languages have been acquired from the candidate language list (Step S7). If all the candidate languages have not been acquired (Step S7: No), the process after the above-described Step S4 is repeated. If all the candidate languages have been acquired (Step S7: Yes), the first determining unit 22 identifies the candidate language with the highest recognition rate (Step S8) and determines that the identified candidate language is the translation source language (Step S6).

After the above-described Step S6, the second determining unit 23 determines a translation target language from the display language information (Step S9). Furthermore, the operation at Step S9 may be performed in parallel with the above-described operation to determine the translation source language, or it may be performed before the operation to determine the translation source language.

Next, the translating unit 24 performs a translation operation to convert the text data that is represented by using the translation source language into the text data that is represented by using the translation target language (Step S10). Next, the translation-result transmitting unit 25 transmits the translation data and the FAX data to the storage server 3 (Step S11).

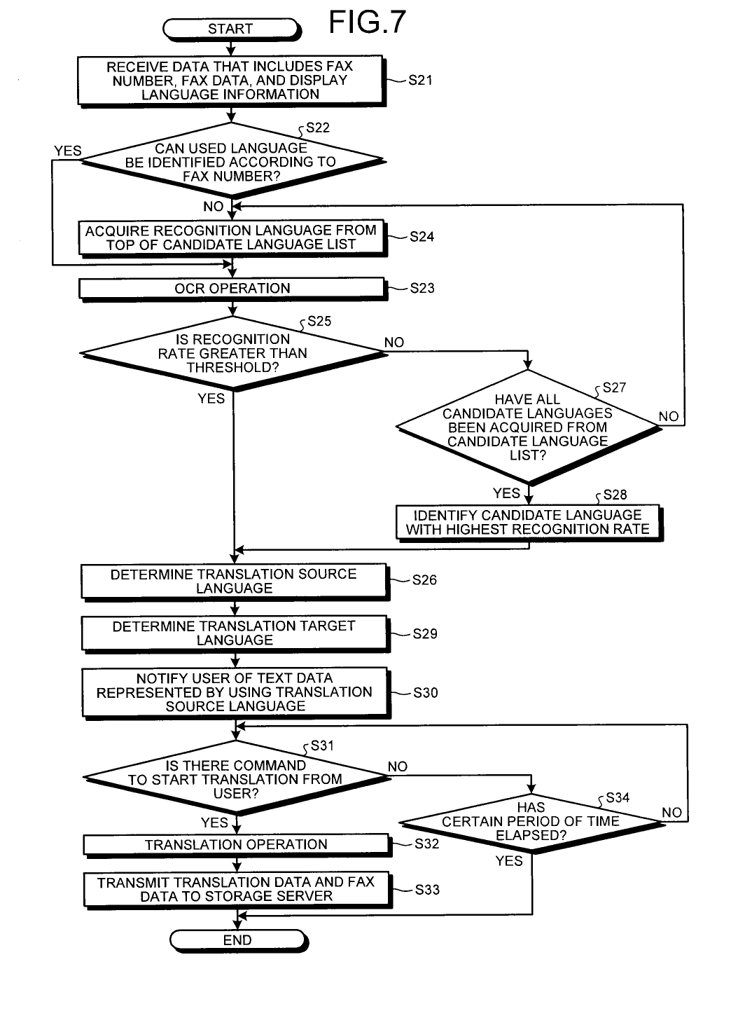

Next, with reference to FIG. 7, an explanation is given of an operation example of the translation server 2 when a translation operation is performed as a manual operation. FIG. 7 is a flowchart that illustrates an operation example of the translation server 2 when a translation operation is performed as a manual operation. The details of the operations from Steps S21 to S29 illustrated in FIG. 7 are the same as those of the operations at Steps S1 to S9 illustrated in FIG. 6 and therefore the detailed explanations are omitted.

At Step S30 illustrated in FIG. 7, the translation server 2 notifies a user of text data (the result of an OCR operation for which the translation source language is used as a recognition language) that is represented by using the translation source language (Step S30). Here, the translation server 2 may also notify a user of the information that indicates the translation target language that is determined at Step S16. Then, if a command to start a translation is received from a user (Step S31: Yes), the translating unit 24 performs a translation operation to convert the text data that is represented by using the translation source language into the text data that is represented by using the translation target language (Step S32), and the translation-result transmitting unit 25 transmits the translation data and the FAX data to the storage server 3 (Step S33). Conversely, if a command to start a translation is not received during a certain period of time (Step S31: No and Step S34: Yes), a translation operation is not performed and the process is terminated.

As described above, according to the present embodiment, the translation source language is determined on the basis of the result of an OCR operation during which characters included in FAX data (image data) are recognized and text data is generated. More specifically, if the recognition rate, which indicates the result of an OCR operation for which the language used in the country or region that is determined according to the FAX number is used as a recognition language, exceeds a threshold, it is determined that the language used in the country or region that is determined according to the FAX number is the translation source language. Conversely, if the recognition rate, which indicates the result of an OCR operation for which the language used in the country or region that is determined according to the FAX number is used as a recognition language, is equal to or less than a threshold, an OCR operation is performed with respect to each of predetermined candidate languages by using the corresponding candidate language as a recognition language, and it is determined that the candidate language with the highest recognition rate that indicates the result of the OCR operation is the translation source language.

Furthermore, according to the present embodiment, it is determined that the language used for a display in the image forming apparatus 1 is the translation target language. More specifically, it is determined that the language (the language that is indicated by the above-described display language information) that is set as the language for a display in the image forming apparatus 1 is the translation target language.

Thus, according to the present embodiment, it is possible to automatically set the translation source language and the translation target language.

### Second Embodiment

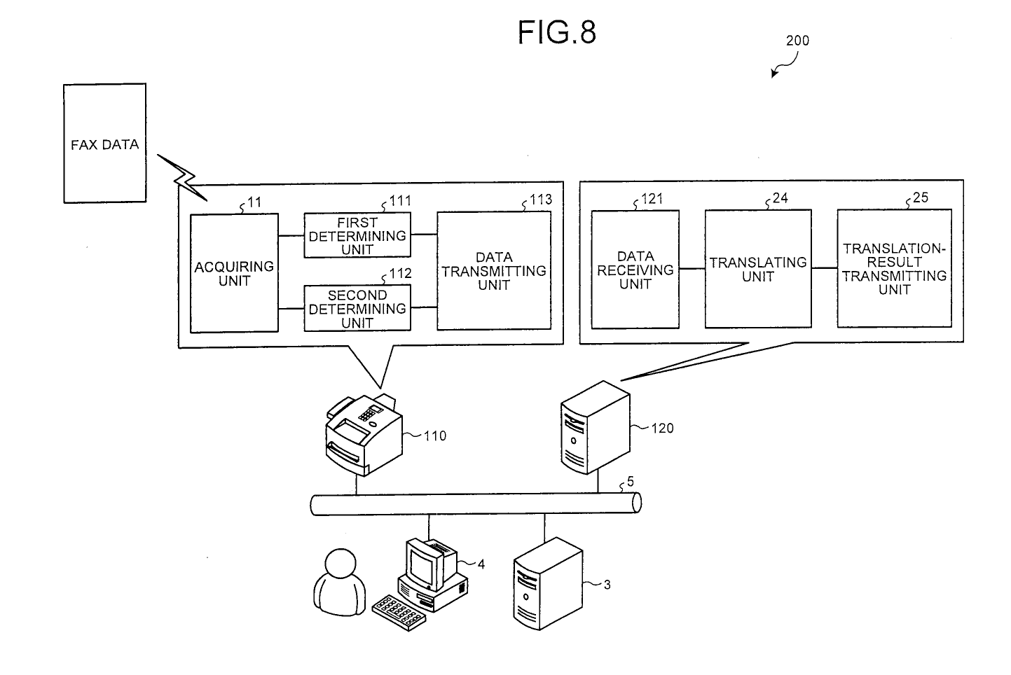

Next, a second embodiment is explained. The explanation for the same part as that in the above-described first embodiment is omitted. FIG. 8 is a diagram that illustrates an example of the configuration of an information processing system 200 according to the second embodiment. As illustrated in FIG. 8, the information processing system 200 includes an image forming apparatus 110, a translation server 120, the storage server 3, and the PC 4. The present embodiment is different from the above-described first embodiment in that the function to determine the translation source language and the translation target language is installed in the image forming apparatus 110 instead of the translation server 120.

As illustrated in FIG. 8, the image forming apparatus 110 includes the acquiring unit 11, a first determining unit 111, a second determining unit 112, and a data transmitting unit 113. The functionality of the acquiring unit 11 is the same as that in the first embodiment, and the acquiring unit 11 transmits, to the first determining unit 111, the FAX number and the FAX data that are received via a phone line or the network 5. Furthermore, in this example, the acquiring unit 11 also has a function to acquire the display language information, and it transmits the acquired display language information to the second determining unit 112.

The functionality of the first determining unit 111 is the same as that of the first determining unit 22 that is described in the first embodiment. The functionality of the second determining unit 112 is also the same as that of the second determining unit 23 that is described in the first embodiment. In this example, the acquiring unit 11 acquires the display language information; however, this is not a limitation, and a configuration may be such that, for example, the second determining unit 112 acquires the display language information.

The data transmitting unit 113 transmits, to the translation server 120, the text data that is represented by using the translation source language, the information that indicates the translation source language, and the information that indicates the translation target language. In this example, the data transmitting unit 113 is equivalent to “a transmitting unit” in claims. For example, a configuration may be such that the functionality of the second determining unit 112 is installed in the translation server 120 and the data transmitting unit 113 transmits, to the translation server 120, the text data that is represented by using the translation source language, the information that indicates the translation source language, and the display language information.

As illustrated in FIG. 8, the translation server 120 includes a data receiving unit 121, the translating unit 24, and the translation-result transmitting unit 25. The data receiving unit 121 receives, from the image forming apparatus 110, data that includes the text data that is represented by using the translation source language, the information that indicates the translation source language, and the information that indicates the translation target language. Then, the data receiving unit 121 transmits, to the translating unit 24, the text data that is represented by using the translation source language, the information that indicates the translation source language, and the information that indicates the translation target language, which are included in the received data. The functionality of each of the translating unit 24 and the translation-result transmitting unit 25 is the same as that in the above-described first embodiment.

Furthermore, a configuration may be such that the acquiring unit 11, the first determining unit 111, the second determining unit 112, and the data transmitting unit 113 that are installed in the image forming apparatus 110 according to the present embodiment are separately installed in multiple servers. Furthermore, a configuration may be such that the data receiving unit 121, the translating unit 24, and the translation-result transmitting unit 25 that are installed in the translation server 120 according to the present embodiment are separately installed in multiple servers. In short, a configuration may be such that the information processing system according to the present invention has the functionality that corresponds to the above-described acquiring unit 11, the functionality that corresponds to the above-described first determining unit 111, the functionality that corresponds to the above-described second determining unit 112, and the functionality that corresponds to the above-described translating unit 24.

For example, a configuration may be such that the translation source language is determined without considering the FAX number. For example, the above-described first determining unit (22, 111) may perform, with respect to each of predetermined candidate languages, an OCR operation by using the corresponding candidate language as a recognition language and determine that the candidate language with the highest recognition rate that indicates the result of the OCR operation is the translation source language.

Furthermore, a configuration may be such that the program that is executed by the image forming apparatus (1, 110) or the translation server (2, 120) according to the above-described embodiment is provided by being stored, in the form of a file that is installable and executable, in a recording medium readable by a computer, such as a CD-ROM, a flexible disk (FD), a CD-R, or a digital versatile disk (DVD), or a universal serial bus (USB), or a configuration may be such that it is provided or distributed via a network, such as the Internet. Furthermore, a configuration may be such that various programs are provided by being previously installed in a non-volatile storage medium, such as a ROM.

According to the present embodiments, it is possible to automatically set the translation source language and the translation target language.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system comprising:
an acquiring unit that acquires first information that includes image data;
a first determining unit that determines a translation source language that indicates a language used in the image data in accordance with a result of a character recognition operation during which a character included in the image data is recognized and text data is generated;
a second determining unit that determines that a language used for a display in an information processing apparatus is a translation target language; and
a translating unit that performs a translation operation to convert the text data that is represented by using the translation source language into the text data that is represented by using the translation target language.

2. The information processing system according to claim 1, wherein
the first information includes second information that makes it possible to determine a country or region, and
the first determining unit determines the translation source language in accordance with the second information and a result of the character recognition operation.

3. The information processing system according to claim 2, wherein the first determining unit determines that a language used in a country or region that is determined according to the second information is the translation source language if a recognition rate exceeds a threshold, the recognition rate indicating a result of the character recognition operation in which the language used in the country or region that is determined according to the second information is used as a recognition language.

4. The information processing system according to claim 3, wherein, if a recognition rate indicating a result of the character recognition operation in which a language used in a country or region that is determined according to the second information is used as a recognition language is equal to or less than the threshold, the first determining unit performs, with respect to each of predetermined candidate languages, the character recognition operation by using a corresponding candidate language as a recognition language and determines that the candidate language with a highest recognition rate that indicates a result of the character recognition operation is the translation source language.

5. The information processing system according to claim 2, wherein the second information is a FAX number that indicates a FAX transmission source.

6. The information processing system according to claim 1, wherein, with respect to each of predetermined candidate languages, the first determining unit performs the character recognition operation by using a corresponding candidate language as a recognition language and determines that the candidate language with a highest recognition rate that indicates a result of the character recognition operation is the translation source language.

7. The information processing system according to claim 1, further comprising a setting unit that sets a target area in the image data for the character recognition operation.

8. The information processing system according to claim 1, wherein the second determining unit determines that a language that is set as a language for a display in the information processing apparatus is the translation target language.

9. An information processing apparatus comprising:
an acquiring unit that acquires first information that includes image data;
a first determining unit that determines a translation source language that indicates a language used in the image data in accordance with a result of a character recognition operation during which a character included in the image data is recognized and text data is generated;
a second determining unit that determines that a language used for a display in an information processing apparatus is a translation target language; and
a transmitting unit that transmits, to a translation server that performs a translation, the text data that is represented by using the translation source language, information that indicates the translation source language, and information that indicates the translation target language.

10. An information processing method performed by an information processing apparatus, the information processing method comprising:
acquiring first information that includes image data;
determining a translation source language that indicates a language used in the image data in accordance with a result of a character recognition operation during which a character included in the image data is recognized and text data is generated;
determining that a language used for a display in the information processing apparatus is a translation target language; and
transmitting, to a translation server that performs a translation, the text data that is represented by using the translation source language, information that indicates the translation source language, and information that indicates the translation target language.
